(19) United States
(12) Patent Application Publication
(10) Pub. No.: US 2020/0032825 A1
(43) Pub. Date: Jan. 30, 2020

(54) SEPARATING DEVICE WHICH CAN BE ARRANGED BETWEEN TWO MOUNTINGS

(71) Applicant: A. RAYMOND ET CIE, Grenoble (FR)

(72) Inventor: David Lamoureux, Grenoble (FR)

(21) Appl. No.: 16/472,777

(22) PCT Filed: Dec. 21, 2017
(86) PCT No.: PCT/EP2017/084071

§ 371 Date: Jun. 21, 2019

(30) Foreign Application Priority Data
Dec. 23, 2016 (FR) 1663337

(51) Int. Cl. F16B 5/02; F16B 37/04

(52) U.S. Cl. CPC F16B 5/0233; F16B 37/044

(57) ABSTRACT

A separating device includes an attachment part and a separating part. The attachment part and the separating part are assembled together and can move relative to one another in an axial direction in order to adjust the separating device. The separating device comprises a driving ring, accommodated in the separating part and capable of being rotated by a tool, the driving ring comprising at least one first coupling means capable of engaging with a second coupling means of the separating part, forming a claw system, for selectively coupling and uncoupling the driving ring and the separating part.

### CROSS-REFERENCE TO RELATED APPLICATIONS

This application is a national phase entry under 35 U.S.C. § 371 of International Patent Application PCT/NL2017/050815, filed Dec. 21, 2017, designating the United States of America and published in French as International Patent Publication WO 2018/115272 A1 on Jun. 6, 2018, which claims the benefit under Article 8 of the Patent Cooperation Treaty to French Patent Application Serial No. 1663337, filed Dec. 23, 2016.

### TECHNICAL FIELD

This disclosure relates to a separating device that can be placed between two mountings in such a way as to bridge the distance between them. The disclosure has a particular application in the automotive field, to fill the space between a load-bearing element and a roof body of a vehicle and to allow, for example, the fixing of roof bars on this vehicle.

### BACKGROUND

A separating device designed to fill a space between sheet metal elements that make up the structure of a vehicle and to compensate for any dimensional differences that may exist between these elements is known from the document EP2532568. This known separating device comprises an attachment part intended to rest and/or be fixed on a first mounting and a separating part having a support end intended to come into contact with a second mounting, placed opposite the first one. The attachment part and the separating part are assembled together at threads that allow them to be moved relative to each other in an axial direction, to allow the separating device to be adjusted to the distance between the two mountings.

In this quoted document, the separating device is attached to a roof bar placed on the outside of the first mounting by means of a through screw. A bolt and washer system on the outside of the second mounting locks the separating device and holds the fabric bar securely to the first mounting.

The separating device is driven in rotation by the fixing screw of the roof bar. The adjustment to the distance between the two mountings and the attachment of the roof bar (or more generally the locking of the separating device) are carried out simultaneously. If these two functions are not perfectly coordinated, it is possible that the locking will occur before the separating part is perfectly in place, which can lead to the deformation of either mounting.

In addition, the presence of the roof bar on the first mounting side requires working on a second mounting side, inside the vehicle, to adjust the separating device. The small and confined space contributes to making the installation of the separating device difficult.

Documents DE102010037228, JP2011033164, DE202008016230, DE102007037242, DE202008011318 and U.S. Pat. No. 5,288,191 also relate to separating devices comprising a separating part driven by a screw and the driving part. When the separating part comes into contact with one of the mountings, the axial force required to be applied to the separating part is greater than the friction force that allows the screw to drive the separating part, so that this connection is interrupted, and prevents any movement of the separating part. This mechanism requires a fine control of the friction forces and operating clearances between the parts, and does not always allow the separating part to be positioned perfectly in place against the mounting.

This disclosure is intended to compensate for all or part of the above-mentioned disadvantages.

### BRIEF SUMMARY

To reach the aim of the disclosure, the object thereof provides for a separating device comprising:
an attachment part intended to be fixed to a first mounting and having an internal thread;
a separating part having an external thread, a mounting end and a driving end, the separating part being intended to rest on the side of its resting end on a second mounting, arranged opposite the first mounting.

The attachment and separating parts are assembled together at their respective threads and can move relative to each other in an axial direction to adjust the separating device to the distance between the two mountings.

According to the disclosure, the separating device comprises a driving ring, accommodated in the separating part and capable of being rotated by a tool, comprising at least a first coupling means capable of cooperating with a second coupling means of the separating part, forming a dog system, so as to selectively couple and uncouple the driving ring and the separating part.

This allows a precise control of the positioning of the separating part without being dependent on the friction forces that may occur between two parts, which are particularly difficult to control.

According to other advantageous and unrestrictive characteristics of the disclosure, taken alone or in any technically feasible combination:
the attachment part includes a resting body and a retaining member to secure the device to the first mounting;
the driving ring is provided with at least one boss or at least one recess to facilitate the application of a torque by a tool;
the driving ring protrudes beyond the resting end of the separating device, when the first coupling means is coupled to the second coupling means;
the driving ring has a length chosen so that the first coupling means is uncoupled from the second coupling means of the separating part when the resting end of the separating part and the driving ring are flush with each other;
the first coupling means consists of a notch and the second coupling means consists of a slot;
the driving ring has, on the side of its protruding end, a shoulder, with the shoulder and the notch making it possible to hold the driving ring in the separating device;
the separating device comprises, on the side of its resting end, a resting ring that can contain the shoulder of the driving ring;
the driving ring is provided with at least one flexible tab at the end of which the notch is arranged;
the notch is formed on the driving end of the separating part.

### BRIEF DESCRIPTION OF THE DRAWINGS

Other characteristics and advantages of the disclosure will emerge from the detailed description of the disclosure that follows with reference to the accompanying figures on which:

FIGS. 1a to 1c represent respectively in exploded view, in top view and in perspective a separating device according to the disclosure; and

FIGS. 2a to 2c represent the different steps in the implementation of a particular example of the separating device of the disclosure.

### DETAILED DESCRIPTION

A separating device in accordance with the disclosure is intended to fill the space between a first mounting and a second mounting, arranged opposite each other. The term “inner face” refers to the faces of the first and second mountings that are placed opposite each other; and the term “outer face” refers to the faces of the first and second mountings opposite these inner faces. The distance between the first and the second mountings is not precisely known, and the device of the disclosure makes it possible to compensate for these differences that may exist from one point to another of the mountings. As such, several separating devices can be placed between the mountings in order to more precisely control the distance separating them over their entire length.

Usually, these mountings are flat, at least in the vicinity of the position where the separating device is installed. The two mountings may have an angular offset and may not be perfectly parallel to each other.

The first and the second mountings each have one opening facing the other one, allowing the separating device to be placed between the two mountings and allowing the passage of a locking element retained on the side of each external face of the mountings. The separating device may also have the function of allowing the attachment of an additional element to the external surface of one or the other of the mountings. In this case, the locking element, such as a through screw, also allows the complementary element to be firmly pressed against the outside of one of the mountings.

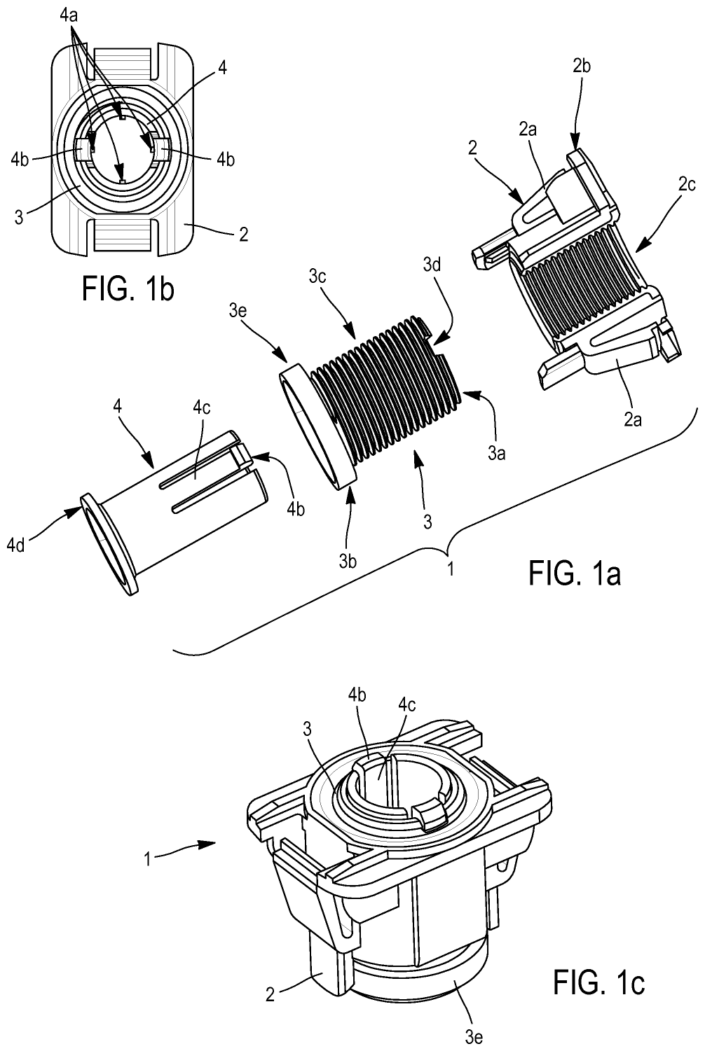

FIGS. 1a, 1b and 1c represent respectively in exploded view, in top view and in perspective a separating device 1 according to the disclosure.

The separating device 1 includes an attachment part 2 with an internal thread or tapping 2c. The attachment part 2 is intended to be secured to the first mounting. For this purpose, it may comprise a retaining element 2a and a resting body 2b. The separating device 1 can be inserted into and positioned in the space between the two mountings through an opening previously provided in the first mounting. The retainer 2a may include one or more flexible tab(s) 2a that contract(s) when the separating device is inserted into the opening to stop the outer face of the first mounting on the resting body 2b, and retract(s) to lock this position. The attachment part 2 may also have a non-circular outer section to block its rotation with respect to the mounting, once installed on the first mounting, as clearly shown in FIG. 1c.

The separating device 1 according to the disclosure also includes a separating device 3 with an external thread 3c. The separating part and the attachment part 2 are designed to be assembled to each other at their respective threads 3c, 2c. The rotational driving of separating part 3 allows the two parts to be moved relative to each other in an axial direction.

The separating part 3 has a hollow cylinder shape, the thread being formed on the outer surface of this cylinder, so that it can be screwed and unscrewed onto/from the attachment part 2.

The separating part 3 has two ends, a first driving end 3a oriented toward the attachment part 2, and a resting end 3b opposite the driving end 3a. When the separating device 1 is placed in the space between the two mountings, the resting end 3b of the separating device 3 has the function of resting on the second mounting to preserve the distance between the two mountings even though stresses tend to bring them closer together.

To enable this resting to be adjusted, the device 1 according to the disclosure also includes a driving ring 4. The driving ring 4 is designed to be accommodated in the separating part 3, for example, inside the hollow cylinder. The driving ring 4 can itself be shaped like a hollow cylinder, the outer diameter of which corresponds approximately to the inner diameter of the cylinder forming the separating part 3, so that it can be inserted into it.

The driving ring 4 has at least one recess or one boss 4a that allows a driving torque to be applied to the ring 4 by means of a suitable tool in order to move it in rotation. The recess or the boss can be formed on the inner wall of the ring 4. A plurality of such indentations or bosses can be arranged to form a slit, a star, a square in the driving ring 4 to facilitate the cooperation with the end of a tool, such as a screwdriver, and its rotational driving.

According to the disclosure, the main function of the driving ring 4 is to drive the separating part 3, when it is itself driven in rotation by a tool. The separating part 3 can thus be screwed and/or unscrewed into/from the attachment fixing part 2, and the axial displacement of the separating part 3 can be adjusted to bring the resting end 3b into contact with the second mounting.

For this purpose, the driving ring 4 is provided with at least one first coupling means 4b, for example, a notch 4b as shown in the FIGS. 1a to 1c, and the separating part 3 is provided, on the side of its driving end 3a, with at least one second coupling means 3d, such as a groove 3d. Preferably, the ring 4 and the separating part 3 are each provided with a plurality of first and second coupling means, such as notches 4b and slots 3d.

The assembly formed by the ring 4 with the first coupling means 4b and the separating part 3 with the second coupling means 3d form a dog system, allowing these two elements to be selectively coupled and uncoupled from each other.

Thus, as shown in the FIGS. 1a to 1b, the notch 4b can be placed in the groove 3d so that the driving ring 4 and the separating part 3 can be coupled. In this coupling configuration, an axial torque applied to the driving ring 4 is transmitted to the separating part 3.

Advantageously, the notch 4b is carried by a flexible tongue 4c formed on or in the cylindrical wall of the driving ring 4. This allows the driving ring 4 to be slid into the separating part 3 by its resting end 3 and the notch 4b to open in the slot 3d.

According to a particularly advantageous embodiment of the disclosure, the driving ring 4, when accommodated in the separating part 3 and the notch 4b positioned in the groove 3d, protrudes beyond the resting end 3b of the separating part 3. The protruding end of the driving ring 3 can be equipped with a shoulder 4d to limit the amplitude of the sliding movement or the travel of the ring 4 in the cylindrical recess of the separating part 3. The notch 4b on one side and the shoulder 4d on the other side of the driving ring 4 form mechanical stops to hold the ring 4 accommodated in the separating part 3.

The support end 3b of the separating part 3 may include a resting ring 3e, the dimensions of which are sufficient to accommodate the end of the driving ring 4, and, in particular, of the shoulder 4d. Thus, when the shoulder 4d of the ring 4 is placed so as to abut the separating part 3 in the resting ring 3e, it is likely to come into contact with the second mounting.

Advantageously, the length of the driving ring 4, and more precisely the distance between the notch 4b and the shoulder 4d is such that, when the shoulder 4d and the resting ring 3e are flush with each other, the notch 4b is disengaged from the groove 3d so as to uncouple the separating part 3 and the ring 4. More generally, the driving ring 4 has a length chosen so that the first coupling means 4b is uncoupled from the second coupling means 3d of the separating part 3 when the resting end 3b of the separating part 3 and the driving ring 4 are flush with each other.

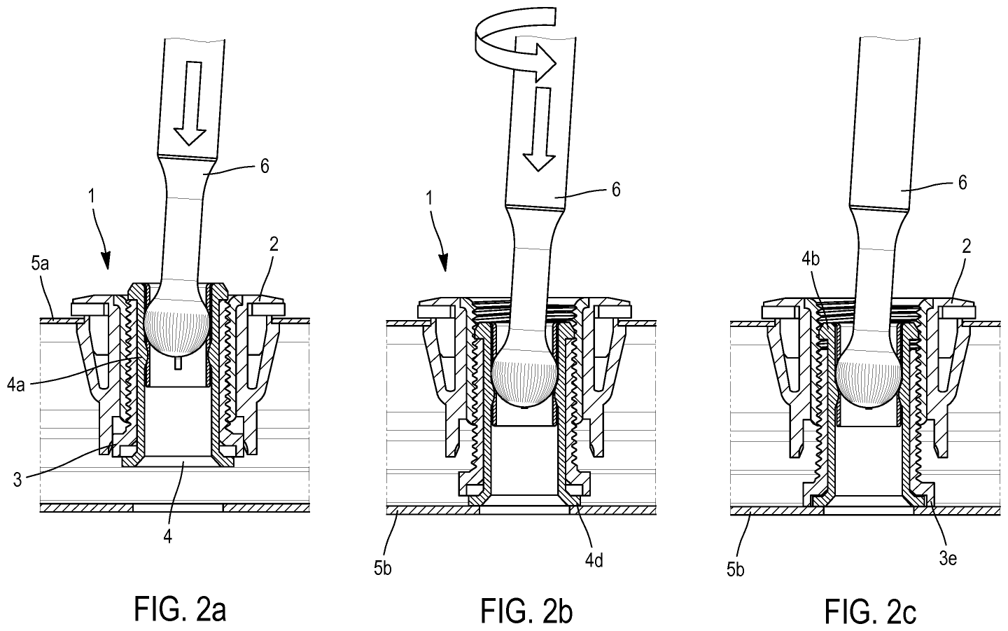

This advantageous configuration can be used to avoid deforming one of the mountings when installing the separating device 1, as will be described in detail in reference to FIGS. 2a to 2c.

FIG. 2a shows a sectional view of a device 1 according to the disclosure attached to a first mounting 5a. A tool 6 is positioned on the side of the attachment part 2, i.e., on the side of the outer face of the first mounting 5a on which the device 1 is fixed. The tool 6 has a head cooperating with the bosses 4a formed on the inner side of the driving ring 4.

The pressure exerted by the tool 6 on the ring 4, possibly supplemented by gravity forces, results in the notch 4b being placed in the groove 3d, so that the ring 4 and the separating part 3 are coupled.

The rotational movement of the tool 6 on itself, possibly supplemented by its inclination, causes the ring 4 and the separating part 3 coupled to it to rotate.

The threads 2c, 3c with which the attachment and separating parts 2, 3 are equipped cause the separating part 2 and the ring 4 to move axially until the shoulder 4d comes into contact with the second mounting 5b, as shown in FIG. 2b.

The maintained rotational movement of the tool 6 continues to cause the axial displacement of the separating part 3, but not of the ring 4 that abuts on the mounting 5b.

When the ring 3e in turn comes to rest on the mounting 5b, the notch 4b disengages from the groove 3d of the separating part 3 and uncouples the driving ring 4 from this part. The rotational movement of the tool 6, if maintained, no longer causes the separating part 3 to rotate, and its axial movement is interrupted.

The disengagement mechanism described above makes it possible to install the separating device 1 without taking the risk of excessively spreading the two supports 5a, 5b from each other.

When the separating device 1 is also used as an attachment mounting for fixing an additional element, the installation and adjustment of the separating device 1 is carried out before positioning the additional element, for example, on the outer face of the first mounting 5b, at the level of the attachment part 2. The tool 6 can therefore be inserted on this side of the mounting for the installation of the device 1, then the possible additional element can be fixed on the attachment part 2 during a final assembly step, for example, by inserting a through screw, inserted on the side of the external face of the second mounting 5b, the additional element then forming a nut.

The disclosure has a very particular application in the field of automobiles, to secure a bar, forming the complementary element, on the roof of a vehicle. The ability to install the separating part without having to access the external face of the second mounting (corresponding to the inside of the vehicle) provides significant ergonomic and time saving.

For reasons of ease of manufacture and cost, the device 1 is advantageously made of plastic material, obtained by molding or extrusion. But it could be made of another material or obtained by another manufacturing process, for example, by additive manufacturing. Of course, the disclosure is not limited to the mode of implementation described and alternative embodiments can be provided without going beyond the scope of the disclosure as defined by the claims.

1. A separating device, comprising:
an attachment part configured to be fixed to a first mounting, the attachment part having an internal thread;
a separating part having an external thread, a support end and a driving end, the support end configured to abut against a second mounting, the second mounting separated from the first mounting by a distance, the attachment part and the separating part being joined together at their respective threads and being movable relative to each other in an axial direction to adjust the separating device to the distance separating the first mounting and the second mounting; and
a drive ring housed in the separating part and capable of being rotated by a tool, the drive ring comprising at least a first coupling feature capable of engaging with a second coupling feature of the separating part for selectively coupling and uncoupling the drive ring and the separating part.

2. The separating device of claim 1, wherein the attachment part comprises a resting body and a retention member configured to fix the device to the first mounting.

3. The separating device of claim 2, wherein the drive ring comprises at least one boss or at least one recess configured to enable application of a torque to the drive ring by a tool.

4. The separating device of claim 3, wherein the drive ring protrudes beyond the support end of the separating part when the first coupling feature is coupled to the second coupling feature.

5. The separating device of claim 4, wherein the drive ring has a length selected so that the first coupling feature is uncoupled from the second coupling feature of the separating part when the support end of the separating part and the drive ring are flush with each other.

6. The separating device of claim 5, wherein the first coupling feature comprises a notch and the second coupling feature comprises a slot.

7. The separating device of claim 6, wherein the drive ring has a shoulder, the shoulder and the notch enabling retention of the drive ring in the separating part.

8. The separating device of claim 7, wherein the separating part comprises, on the support end side, a resting ring capable of abutting against the shoulder of the drive ring.

9. The separating device of claim 6, wherein the drive ring has at least one flexible tab, the notch being located at an end of the at least one flexible tab.

10. The separating device of claim 6, wherein the notch is located on the driving end of the separating part.

11. The separating device of claim 1, wherein the drive ring comprises at least one boss or at least one recess configured to enable application of a torque to the drive ring by a tool.

12. The separating device of claim 1, wherein the drive ring protrudes beyond the support end of the separating part when the first coupling feature is coupled to the second coupling feature.

13. The separating device of claim 1, wherein the drive ring has a length selected so that the first coupling feature is uncoupled from the second coupling feature of the separating part when the support end of the separating part and the drive ring are flush with each other.

14. The separating device of claim 1, wherein the first coupling feature comprises a notch and the second coupling feature comprises a slot.

15. The separating device of claim 14, wherein the drive ring has a shoulder, the shoulder and the notch enabling retention of the drive ring in the separating part.

16. The separating device of claim 15, wherein the separating part comprises, on the support end side, a resting ring capable of abutting against the shoulder of the drive ring.

17. The separating device of claim 14, wherein the drive ring has at least one flexible tab, the notch being located at an end of the at least one flexible tab.

18. The separating device of claim 14, wherein the notch is located on the driving end of the separating part.
